(19) United States
(12) Patent Application Publication
(10) Pub. No.: US 2006/0050439 A1
(43) Pub. Date: Mar. 9, 2006

(54) Recording medium cartridge and method of welding upper and lower halves of recording medium cartridge

(75) Inventor: Yoichi Hayashi, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/217,327

(22) Filed: Sep. 2, 2005

(30) Foreign Application Priority Data
Sep. 7, 2004 (JP) 259475/2004

(51) Int. Cl. G11B 23/03

(52) U.S. Cl. 360/133

(57) ABSTRACT

When a recording medium cartridge having a flat housing which holds therein a recording medium is produced by butt-splicing peripheral walls of upper and lower shell halves by welding the upper and lower shell halves together at a plurality of points at the peripheral walls, the welding is performed with a center of a laser spot for welding being offset upward or downward from a joint between the opposed abutment portions of the peripheral walls of the upper and lower shell halves, whereby the laser beam can be efficiently prevented from entering the housing through clearance between the opposed abutment portions of the peripheral walls of the upper and lower shell halves during welding.

### BACKGROUND OF THE INVENTION

1. Field of the Invention

The present invention relates to a method of welding an upper shell half and a lower shell half of a recording medium cartridge having a flat housing which accommodates therein a recording medium, comprising the step of spot-welding the upper and lower shell halves together at a plurality of points at opposed abutment portions of peripheral walls of the upper and lower shell halves of the recording medium cartridge. The present invention also relates to a recording media cartridge comprising an upper shell half and a lower shell half which are welded together by the aforementioned method.

2. Description of the Related Art

Conventionally, mobile equipment such as digital cameras, etc., use very small recording medium cartridges called “clik! (registered trademark)” as recording media (see, for example, U.S. Pat. No. 6,133,544).

As shown in FIG. 7 (a perspective view) and FIGS. 8A and 8B (a plan view and a bottom view), the recording medium cartridge 1 comprises: a flat housing (width 50 mm, depth 55 mm, thickness 1.95 mm) which is constituted by a resin frame 2 (which is called a stabilizer) including a push portion 2a to be pushed with a finger when loading the recording medium cartridge to a drive device, and upper and lower shells 3 and 4 formed of a thin metal sheet of about 0.3 mm thick; and a 1.8 inch (45.7 mm) diameter magnetic recording medium 5 having a 40 MB storage capacity which is rotatably held in the flat housing. A hub (center core) 10 having a center hole 10a is centrally affixed to magnetic recording medium 5.

The recording medium cartridge 1 is designed to be loaded in a TYPE II PC card type drive device (width 53 mm, depth 85 mm, thickness 5 mm, not shown) by insertion of the cartridge 1 into a slot provided in, the drive device. The housing has a wedge-shaped opening 6 formed to allow a recording/reproducing magnetic head of the drive device to access the surface of the magnetic recording medium 5. Further, a rotary shutter 7 having an aperture 7a for pivotally opening and closing the opening 6 is held between the housing and the magnetic recording medium 5. This rotary shutter 7 is designed to be urged towards its closing direction by means of a spring member (not shown) and locked at its closed position by a locking member (not shown) mounted to the upper shell half 3.

FIG. 7, FIG. 8A and FIG. 8B show a state that the aperture 7a of the rotary shutter 7 is positioned within the housing and the opening 6 of the housing is closed by the rotary shutter 7, that is, the opening 6 is in its closed position.

As shown in FIG. 9 which is an enlarged sectional view showing essential parts of the recording medium cartridge taken along line 9-9 in FIG. 8A, the rotary shutter 7 is constituted by upper and lower shutter halves 7U and 7D which are formed from a thin metal plate and engaged with each other at the peripheries thereof. Further, the upper shutter half 7U is rotatably supported by a small diameter cylinder 3a of the upper shell half 3. The cylinder 3a projects inwardly from the lower surface of the upper shell half 3. A retaining member 11 (called a center pin) to prevent the upper shutter half 7U from falling off from the cylinder 3a is welded to the extremity of the cylinder 3a such that the retaining member 11 is disposed within the center hole 10a of the center hub 10. A liner 13, which is for wiping off dirt and dust deposited on the magnetic disk 5 and constructed of, for example, a nonwoven fabric, is affixed to each inner surface of the upper and lower shutter halves 7U and 7D.

The lower shell half 4 is centrally provided with a center hole 4a for exposing the center hub 10 towards the outside. A large diameter cylinder 7Da extending downwardly is provided at the central portion of the lower shutter half 7D and loosely engaged with the edge of the center hole 4a of the lower shell 4S. The lower shell half 4 rotatably supports the lower shutter half 7D via this large diameter cylinder 7Da. The distal end of the large diameter cylinder 7Da is caulked to form a flange 12 so as to prevent the lower shutter half 7D from falling off from the lower shell half 4.

As shown in FIG. 8B, an arcuate groove 4b concentric with the rotary shutter 7 is formed in the lower shell half 4, while a shutter knob 7b which protrudes through the arcuate opening 4b and travels along this arcuate opening 4b to allow opening and closing of the rotary shutter 7 is affixed to the lower shutter half 7D. As the recording medium cartridge 1 is inserted (pushed) for loading into the drive device, the locking member is disengaged from locking the rotary shutter 7 at its closed position, allowing the rotary shutter 7 to rotate. An engaging wall of the drive device is then engaged with the shutter knob 7b and the rotary shutter 7 is in turn rotated about 60° to its open position, where the aperture 7a of the rotary shutter 7 is aligned with the both openings 6 of the upper and lower shell halves 3 and 4. Thus, the recording medium cartridge 5 is loaded in the drive device with the magnetic disk 5 being exposed through the openings 6 of the housing as shown in FIGS. 10A and 10B (views from above and below).

Further, the recording medium cartridge 1 is designed to release engagement with the drive device when the recording medium cartridge 1 is pushed inward again, so that the recording medium cartridge 1 is enabled to be removed from the drive device and the rotary shutter 7 is urged by a spring member (not shown) to be returned to the closed position as shown in FIGS. 8A and 8B.

As illustrated on the right end in FIG. 9, the upper and lower shell halve 3 and 4 are assembled by butt-joining the edges of the peripheral walls of the upper and lower shell halves 3 and 4 and then spot-welding the upper and lower shell halves 3 and 4 together at thirteen points W₁ to W₁₃ located along the joined edges using a laser beam as shown in FIG. 8A.

It is desirable that no clearance remains between the opposed abutment portions of the peripheral walls of the upper and lower shell halves 3 and 4. However, as a practical matter, it is impossible to completely eliminate such clearance and it is usually the case that a slight clearance remains at the laser spot for welding.

On the other hand, when laser welding is used, energy as large as several kW can be concentrated at a very small spot having a diameter less than 1 mm, which causes vigorous vaporization at the laser-irradiated spot. Heat obtained from the laser beam and a reaction force as a consequence of the vigorous vaporization cause progress on welding while forming a deep hole called a keyhole at the laser-irradiated portion, which allows deep penetration welding.

However, when the joint between the opposed abutment portions is coincident with the center of a laser spot for welding, even if a boiling melt does not yet reach the rear surface at the abutted portion, weld slag, gas, and/or metal oxide particles leaks out from the clearance between the opposed abutment portions and would be deposited on a component such as a rotary shutter 7, possibly on the recording medium. Further, the dust and foreign matter thus deposited on the outer surface of the rotary shutter 7 may fall off during use of the cartridge at a later date for any reason such as vibration, and cause a fatal error such that the dust or the like is adhered on the recording medium or the recording/reproducing magnetic head. SUMMARY OF THE INVENTION

In view of the foregoing observations and description, an object of the invention is to prevent the laser beam from leaking into the housing through the aforementioned clearance during welding.

A first aspect of the invention provides a method of welding an upper shell half and a lower shell half of a recording medium cartridge having a flat housing which accommodates therein a recording medium, comprising the step of spot-welding the upper and lower shell halves together at a plurality of points at opposed abutment portions of peripheral walls of the upper and lower shell halves of the recording medium cartridge, wherein the welding is performed with the center of a laser spot for welding being offset upward or downward from a joint between the opposed abutment portions of the peripheral walls of the upper and lower shell halves.

It is preferable that the welding is performed with the offset distance of the center of a laser spot for welding from the joint between the opposed abutment portions being set within the range of about 30 μm to about 10% of the diameter of the melting portion. Therefore, when the diameter of the melting portion is about 0.8 mm, the offset distance is preferably in the range from about 30 μm to about 80 μm, and most preferably about 50 μm.

A second aspect of the invention provides a recording medium cartridge having a flat housing which accommodates therein a recording medium, the flat housing being produced by spot-welding an upper shell half and a lower shell half together at a plurality of points at abutment portions of peripheral walls of the upper and lower shell halves, wherein the center of a melting portion to be melted by the spot-welding is offset upward or downward from a joint between the opposed abutment portions of the peripheral walls of the upper and lower shell halves.

According to the first and second aspects of the invention, the welding is performed with the center of a laser spot for welding being offset upward or downward from a joint between the opposed abutment portions of the peripheral walls of the upper and lower shell halves. As a result, the laser beam can be efficiently prevented from entering the housing through any clearance between the opposed abutment portions of the peripheral walls of the upper and lower shell halves during welding.

In this case, the effect as a result of offset is insufficient when the offset distance of the center of a laser spot for welding from a joint between the opposed abutment portions is less than 30 μm. Meanwhile, an excessive offset distance of the center of a laser spot for welding from the joint between the opposed abutment portions, as large as about 10% or more of the diameter of the melting portion, reduces the welding quality. Thus, the most preferable offset distance is about 50 μm.

### BRIEF DESCRIPTION OF THE DRAWINGS

FIG. 1A is an enlarged front view provided for illustrating a welding method of the invention, showing a welding point before welding; FIG. 1B is an enlarged front view showing the welding point after welding; and FIG. 1C is a schematic sectional view of the welding point.

FIG. 2 is a plan view of a holding stage used for performing the welding method of the invention.

FIG. 3 is a front view of the holding stage shown in FIG. 2.

FIG. 4 is a side view of a shutter lever shown in FIG. 2.

FIG. 5 is a plan view of a modification of the shutter lever.

FIG. 6 is a front view of a rod used for performing the welding method of the invention.

FIG. 7 is a perspective view of a conventional recording medium cartridge.

FIG. 8A is a plan view and FIG. 8B is a bottom view, showing the recording medium cartridge of FIG. 7 with the rotary shutter being in its closed position.

FIG. 9 is an enlarged cross-sectional view taken along line 9-9 in FIG. 8A.

FIG. 10A is a plan view and FIG. 10B is a bottom view, showing the recording medium cartridge in FIG. 7 with the rotary shutter being in its open position.

### DESCRIPTION OF THE PREFERRED EMBODIMENTS

Embodiments of the present invention will hereinafter be described in detail with reference to the drawings.

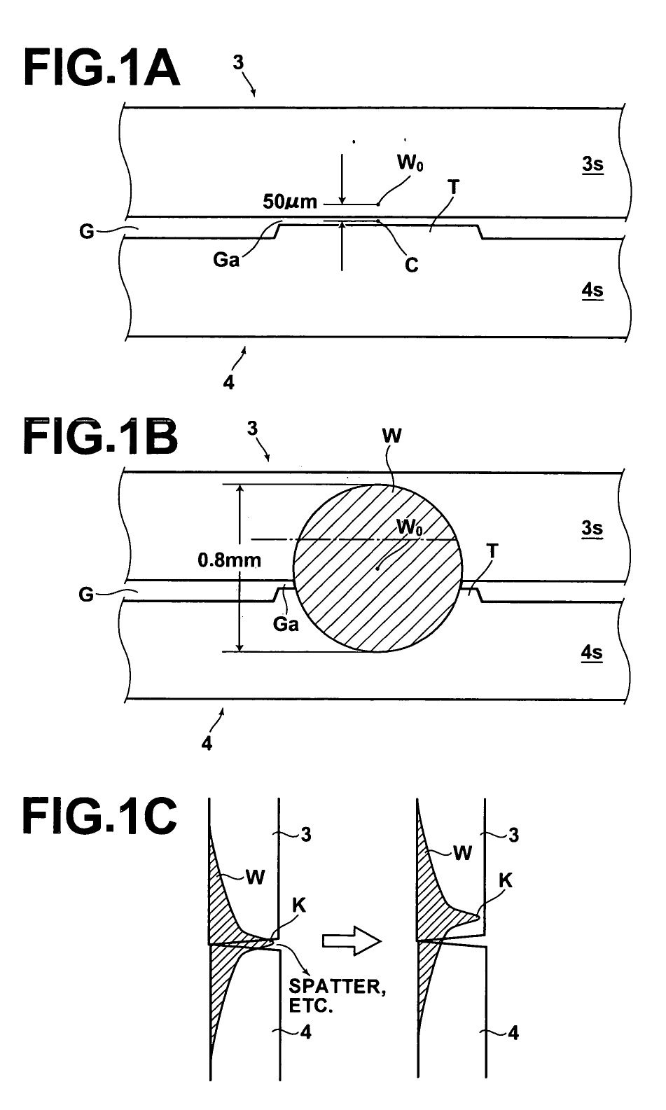

FIGS. 1A and 1B are enlarged front views provided for illustrating a welding method for joining an upper shell half and a lower shell half of a recording medium cartridge according to the invention, respectively showing a state before welding and after welding. FIG. 1C is a schematic sectional view of the welding point.

Referring to FIGS. 1A and 1B, a margin T for welding is formed at welding points at abutment portions of peripheral walls 3s and 4s of lower shell halves 3 and 4. The margin T which has, for example, a height of about 30 μm and a width of about 1 mm may be formed so as to extend from the peripheral wall 4s of the lower shell half 4. As a result, a clearance Ga between the opposed abutment portions of the peripheral walls 3s and 4s becomes not more than 20 μm, which is narrower than the clearance G (about 50 μm) of the remaining region. A center W₀ of a melting portion W may be set at a position disposed closer to the upper shell half 3, for example, at a position which is offset about 50 μm upward from a point C located approximately in the center of a aforementioned clearance Ga.

The present invention discussed hereinafter contemplates welding wherein the center W₀ of a laser spot for welding produced by a laser beam is offset upward or downward from a joint between the opposed abutment portions at the peripheral walls 3s and 4s of the upper and lower shell halves 3 and 4. It is preferable that the offset distance of the center W₀ of the laser spot for welding from the joint between the opposed abutment portions is in a range from about 30 μm to about 10% of a diameter of the melting portion W. Therefore, when the diameter of the melting portion is about 0.8 mm, the offset distance is preferably in the range from about 30 μm to about 80 μm, and most preferably about 50 μm.

The left part of FIG. 1C shows a case where the center W₀ of the laser beam where a keyhole K is formed is set at a joint between the opposed abutment portions of the peripheral walls 3s and 4s of the upper and lower shell halves 3 and 4, as a result of which weld slag or the like is dispersed from the clearance between the opposed abutment portions. When the center W₀ of the laser beam where a keyhole K is formed is set at a position which is offset closer (for example, 50 μm) to the upper shell half 3 as shown in the right part of FIG. 1C, the dispersion of weld slag or the like from the clearance between the opposed abutment portions can be efficiently prevented.

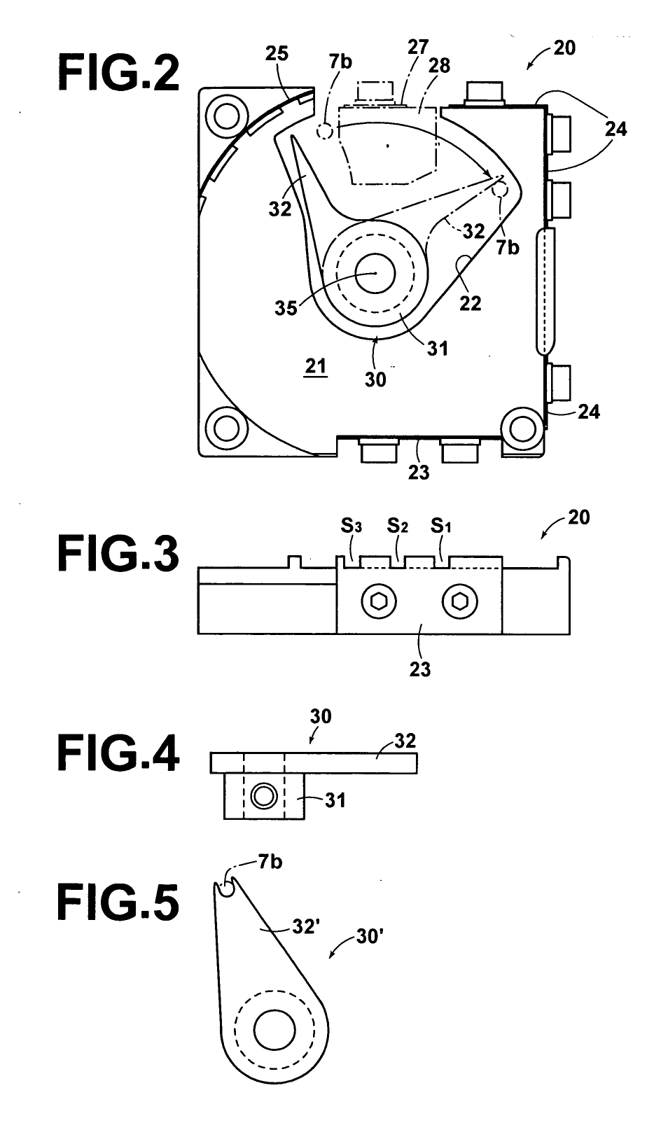

FIG. 2 is a plan view of a holding stage 20 which is used for welding the upper and lower shell halves 3 and 4 of the recording medium cartridge 1, and FIG. 3 is a front view of the holding stage 20.

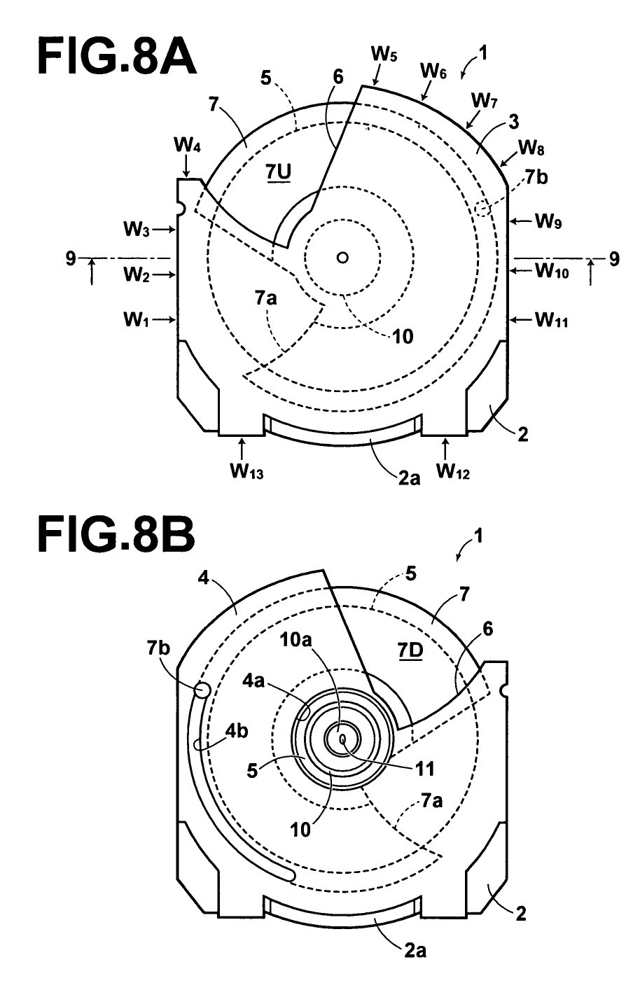

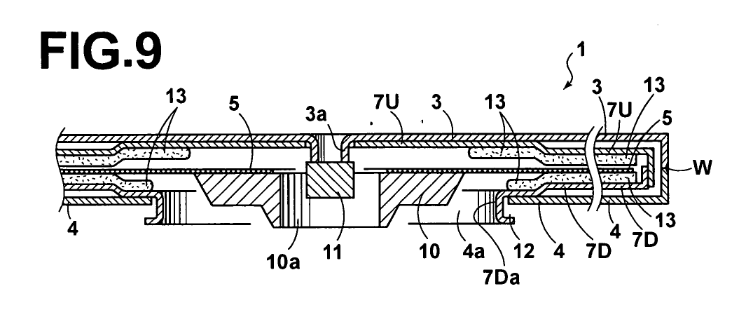

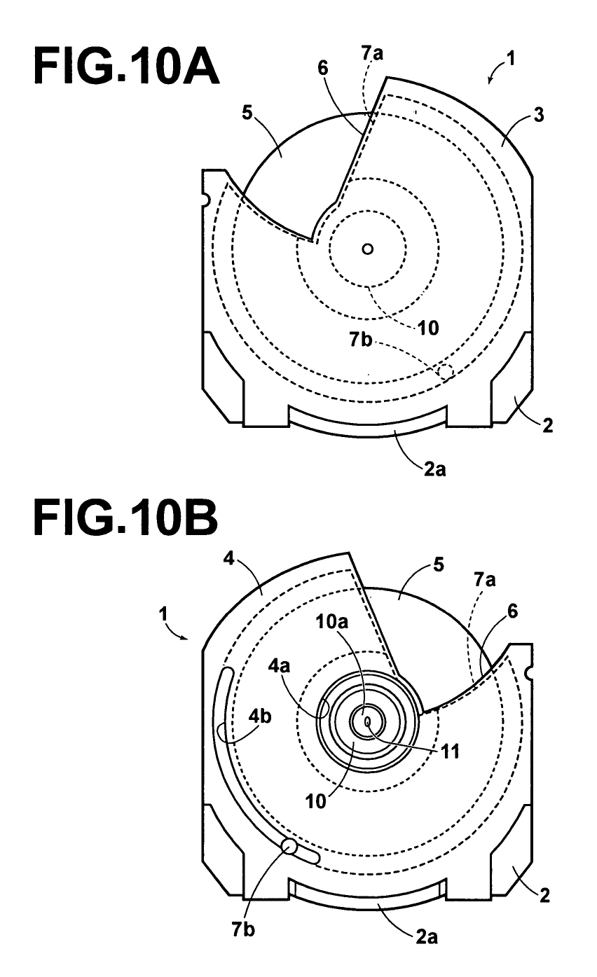

This holding stage 20 comprises a flat cartridge-supporting surface 21 on which the recording medium cartridge 1 is supported in a manner such that at least a peripheral portion of a main surface of the lower shell half 4 is in contact with cartridge-supporting surface 21 when the recording medium cartridge 1 is positioned on the holding stage 20 with a frame 2 of the cartridge facing rightward as viewed in the drawing and the upper shell half 3 being located above the lower shell half 4; and a cavity 22 which is generally arcuate when viewed from above and has an opening in the cartridge-supporting surface 21. This cavity 22 serves as a space within which a shutter lever 30 is pivoted during rotation from the closed position to the open position (as shown in FIG. 8A) a rotary shutter 7 of the recording medium cartridge 1 locked on the holding stage 20. Side guides 23, 24 and 25 composed of plate springs are affixed around the holding stage 20 and cooperate to elastically lock the peripheral walls of the upper and lower shell halves 3 and 4 from the side.

As shown in the side view of FIG. 4, the shutter lever 30 comprises a boss portion 31 to be affixed to a rotary wheel 35, and a lever portion 32 having a distal end which engages from one side with a shutter knob 7b of the recording medium cartridge 1 locked on the holding stage 20.

The side guides 23, 24 and 25 are elastically urged against the peripheral surfaces of the upper and lower shell halves 3 and 4. The side guides 23, 24 and 25 serve to position the shell halves 3 and 4 so as to prevent lateral displacement between the opposed abutment portions of the peripheral walls of the upper and lower shell halves 3 and 4, and also serve to cover the butting parts except the welding point such that the weld slag or the like produced during welding enters the interior of the shell halves 3 and 4 through the clearance between the upper and lower shell halves. For example, in the side guide 23, slits S₁ to S₃ are formed at positions corresponding to welding points W_{1 to W}₃ as shown in FIG. 3 such that laser welding is carried out through these slits S₁ to S₃. Though not shown, other side guides 24 and 25 are similarly provided with slits at positions corresponding to respective welding points.

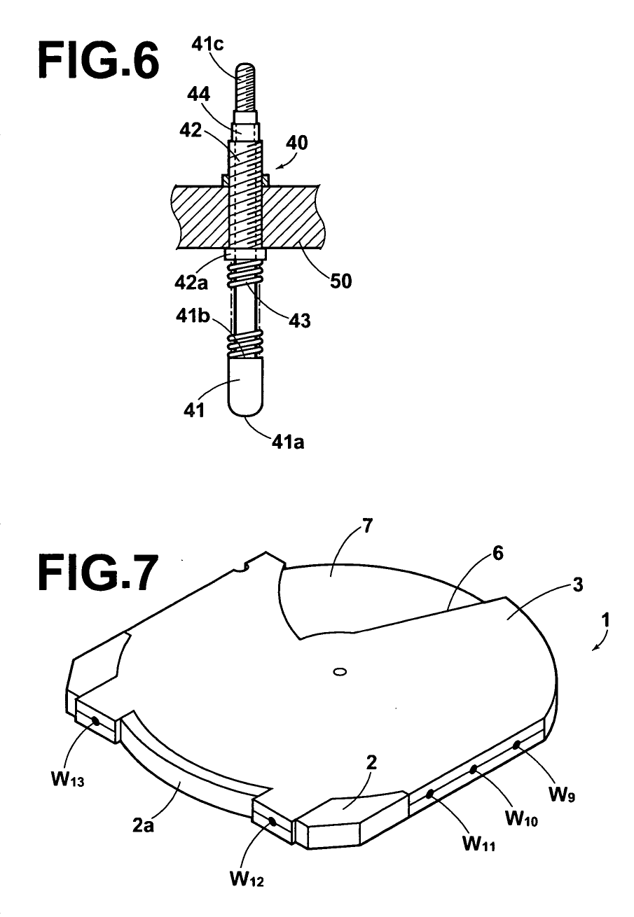

FIG. 6 shows a pressing rod 40 for pressing the upper shell half 3 at a portion near each welding point W₁ to W₁₃ of the peripheral portion of the main surface of the upper shell half 3. Specifically, the thirteen pressing rods are mounted on a rod holding member 50.

Each pressing rod 40 is constituted by: a rod body 41 which has a rounded bottom surface 41a to be brought into contact with the upper shell half 3 at a portion near any of the welding points W₁ to W₁₃ of the peripheral portion of the main surface of the upper shell half 3; a casing 42 which is vertically slidably fitted over the rod body 41, has a threaded exterior, and is mounted in an axially adjustable manner to the rod holding member 50; a coil spring 43 which is positioned in a compressed state between a step portion 41b formed on the rod body 41 and a flange 42a provided at the lower end of the casing 42; and an adjusting nut 44 which is screwed onto the top portion 41c of the rod body 41 and used for adjusting the spring-urging force of the coil spring 43.

Since the thirteen pressing rods 40 having such a design are mounted to the rod holding member 50, it becomes possible to individually adjust a relative position and a contact pressure of the bottom surface 41a of the rod body 41 with respect to the peripheral portion of the main surface of the upper shell half 3.

Hereafter a description will made on how to weld the upper and lower shell halves 3 and 4 using the holding stage 20 and the pressing rod 40.

First, the upper and lower shell halves 3 and 4 are positioned on the holding stage 20 with the shutter lever 30 being held at a position shown solid lines in FIG. 2 such that the lower shell half 3 is positioned below the upper shell half 4 and the edge of the peripheral walls are abutted one another. Then the peripheral walls of the upper and lower shell halves 3 and 4 are held between the side guides 23 to 25 from the side such that lateral displacement between the upper and lower halves 3 and 4 is eliminated.

A movable holding stage 28 provided with a side guide 27 (shown by broken lines) having the same construction as that of the aforementioned side guides 23 to 25 is moved upward to the cavity 22 so as to support at least the peripheral portion of the main surface of the lower shell half 4 located in the region within the cavity 22. The side guide 27 is elastically urged against the peripheral walls of the upper and lower shell halves 3 and 4.

At the same time, the rod holding member 50 is moved downward to cause the thirteen pressing rods 40 to press the upper shell half 3 at portions near the welding points W₁ to W₁₃ (see FIG. 8A) of the peripheral portion of the main surface of the upper shell half 3. Then, the locked state of the rotary shutter 7 is released.

It suffices in this case to ensure, on average, about 200 gf of contact pressure of the rod body 41 for pressing near the welding points W₁ to W₃, W₆ and W₇. Especially, portions susceptible to creation of a clearance between the upper and lower shell halves are as follows: two corners of the shell assembly facing the opening 6 of the upper and lower shell halves 3 and 4 through which a magnetic head accesses the information recording medium; and engagement portions of the shell assembly with the frame 2. Therefore, it is preferable to adjust the contact pressure of the rod body 41 for pressing near the welding points W₁₂ and W₁₃ to ensure about 500 gf, which is more than twice the aforementioned contact pressure. Meanwhile, it is preferable that the contact pressure for pressing near the welding point W₈ is adjusted to ensure about 30 gf which is the smallest contact pressure, since the welding point W₈ is located apart from both the holding stage 20 and the movable holding stage 28. Further, it is also preferable that the rod bodies 41, for pressing near the welding points W₉ to W₁₁ located adjacent a passage for the shutter knob 7b, are adjusted to ensure a relatively low contact pressure, for example, about 100 gf.

Thus, with the peripheral portion of the main surface of the upper shell half 3 being pressed by thirteen pressing rods 40 which have been individually adjusted to ensure respective preferable contact pressures of the rod bodies 41, ten welding points W₄ to W₁₃ are first subjected to welding such that the center W₀ of the laser spot for welding is offset upward or downward from the joint between the opposed abutment portions of the peripheral walls 3s and 4s of the upper and lower shell halves 3 and 4 as shown in FIG. 1. Then, the movable holding stage 28 is moved downward and the shutter lever 30 is pivoted clockwise as viewed in FIG. 2 from a position shown in solid lines to a position shown in broken lines (see FIG. 2) so that an aperture of the rotary shutter 7 is substantially aligned with the opening 6 of the housing. After that, the movable holding stage 28 is moved upward again to the cavity 22 and controlled to support the main surface of the lower shell half 4. In this state, the remaining three welding points W₁ to W₃ are subjected to welding through the slits S₁ to S₃ formed in the side guide 23.

Next, after the movable holding stage 28 is moved downward and then the shutter lever 30 is returned to its original position shown in solid line in FIG. 2, the rotary shutter 7 is also returned to its closed position as shown in FIGS. 8A and 8B by the urging force of a spring member incorporated within the housing. Then, the rod holding member 50 is moved upward to release the recording medium cartridge, and the welding process is completed.

In order to provide a large cartridge-supporting surface 21 by reducing the area of the cavity to be as small as possible, the shutter lever 30 shown in FIGS. 2 and 4 comprises a thin lever portion 32 having a distal end which engages from one side with the shutter knob 7b. However, as shown in FIG. 5, a shutter lever 30′ provided with a lever portion 32′ having a bifurcated distal end which can engage from both sides with the shutter knob 7b may be used. In this case, advantageously, the rotary shutter 7 can be more reliably returned to its closed position.

Further, in the embodiment described above, welding is performed with the lower shell half 4 being positioned under the upper shell half 3. Alternatively, welding may be performed with the lower shell half 4 being positioned above the upper shell half 3. In this case, while it is necessary to provide a shutter lever 30 at a position above the recording medium cartridge 1, this arrangement is advantageous in that a cavity 22 in a holding stage 20 and a movable holding stage 28 become unnecessary.

The above descriptions have fully described the method of welding the upper and lower shell halves 3 and 4 of the particular embodiment of the invention. According to the embodiment, the welding is performed with a center of a laser spot for welding being offset upward or downward from a joint between the opposed abutment portions of the peripheral walls 3S and 4S of the upper and lower shell halves 3 and 4. Therefore, the laser beam can be efficiently prevented from entering the housing through clearance Ga between the opposed abutment portions of the peripheral walls 3S and 4S of the upper and lower shell halves 3 and 4 during welding.

Further, according to the embodiment, the welding is performed with the peripheral walls of the upper and lower shell halves being clamped from the side by means of the side guides 23, 24, 25 and 27 which are composed of plate spring, whereby a lateral displacement between the opposed abutment portions of the upper and lower halves 3 and 4 can be efficiently prevented with a simple structure. Still further, the side guides 23, 24, 25 and 27 are provided with slits at positions corresponding, to the welding points and therefore the welding can be performed through these slits. Thus, the presence of the side guides 23, 24, 25 and 27 does not impede the welding operation, and the side guides 23, 24, 25 and 27 cover the abutment portions except the welding points, whereby the weld slag or the like produced during welding can be prevented from entering the interior of the upper and lower shell 3 and 4 halves through the clearance therebetween.

Still further, the welding is performed with the upper and lower shell halves 3 and 4 being pressed from above against the holding stage 20 at portions near thirteen welding points W₁ to W₁₃ by means of the pressing rods 40 whose pressing forces are individually controlled depending on the positions of the welding points W₁ to W₁₃. Therefore, by pressing with a relatively large pressing force the portions near the welding points W₄ and W₅ which are susceptible to creation of a clearance between the upper and lower shell halves 3 and 4 (such as the portions near the corners of the shell assembly facing the opening 6 of the housing through which a magnetic head accesses), the dimensional accuracy of the entire recording medium cartridge 1 can be enhanced.

While the foregoing embodiment was described in connection with “clik! (registered trademark)” having a magnetic recording medium 5 with an outside diameter of about 1.8 inch (about 46 mm), it is to be understood that the present invention is not limited thereto, but applicable to cartridges comprising a very small high-density recording medium including high-density recording medium having a diameter as small as 1 inch (about 25 mm), 0.8 inch (about 20 mm) or the like, which may be developed at a later date. The recording medium is not limited to a disk, but may be a tape, a hard disk, an optical medium, a semiconductor or the like.

In the exemplary embodiment described above, the rotary shutter 7 is incorporated in the housing. However, it goes without saying that that the invention is applicable to a recording medium cartridge, on the outside of which a rotary shutter or a slide shutter is mounted.

What is claimed is:

1. A method of welding an upper shell half and a lower shell half of a recording medium cartridge having a flat housing which accommodates therein a recording medium, comprising the step of spot-welding the upper and lower shell halves together at a plurality of points at abutment portions of peripheral walls of the upper and lower shell halves of the recording medium cartridge,
wherein the welding is performed with a laser spot for welding being offset upward or downward from a joint between the opposed abutment portions of the peripheral walls of the upper and lower shell halves.

2. The method as set forth in claim 1, wherein the welding is performed with the offset distance of the center of a laser spot for welding from the joint between the opposed abutment portions being set within the range of about 30 μm to about 10% of the diameter of the welding point.

3. The method as set forth in claim 1, wherein the welding is performed with the offset distance of the center of a laser spot for welding from the joint between the opposed abutment portions being set about 50 μm.

4. The method as set forth in claim 1, wherein the welding is carried out in a state in which the upper and lower shell halves are positioned on a holding stage such that the lower shell half is positioned below the upper shell half with edges of the peripheral walls of the upper and lower shell halves being abutted one another and a peripheral portion of the upper shell half undergoes pressing by the pressing rods at portions near the plurality of welding portions.

5. The method as set forth in claim 4, wherein each pressing rod has a rounded bottom surface to be abutted against the upper shell half.

6. The method as set forth in claim 4, wherein the welding is carried out in a state in which contact pressures by the pressing rods against (i) two corners, facing the opening of the upper and lower shell halves 3 and 4, of the upper shell and (ii) engagement portions of the upper shell with the frame are larger than those against other portions to undergo contact pressure.

7. The method as set forth in claim 4, wherein the welding is carried out with the peripheral walls of the upper and lower shell halves being held by side guides from the side.

8. The method as set forth in claim 7, wherein slits through which the welding is carried out are provided in the side guides at positions respectively corresponding to the welding points.

9. A recording medium cartridge having a flat housing which holds therein a recording medium, the flat housing being produced by spot-welding an upper shell half and a lower shell half together at a plurality of points at abutment portions of peripheral walls of the upper and lower shell halves,
wherein the center of a melting portion to be melted by the spot-welding is offset upward or downward from a joint between the opposed abutment portions of the peripheral walls of the upper and lower shell halves.
